(19) United States
(12) Patent Application Publication
(10) Pub. No.: US 2014/0370267 A1
(43) Pub. Date: Dec. 18, 2014

(54) COMPOSITE ELEMENTS WITH IMPROVED DIMENSIONAL STABILITY

(71) Applicant: Bayer Intellectual Property GmbH, Monheim (DE)

(72) Inventors: Rolf Roers, Odenthal (DE); Torsten Hagen, Essen (DE); Rene Abels, Koln (DE); Inge Tinnefeld, Koln (DE); Walter Schindler, Burscheid (DE)

(73) Assignee: Bayer Intellectual Property GmbH, Monheim (DE)

(21) Appl. No.: 14/374,357

(22) PCT Filed: Jan. 30, 2013
(86) PCT No.: PCT/EP2013/051759

§ 371 Date: Jul. 24, 2014

(30) Foreign Application Priority Data
Feb. 2, 2012 (EP) 12153611.4

(51) Int. Cl. C08G 18/76; C08G 18/34; C08G 18/32

(52) U.S. Cl. CPC C08G 18/7671; C08G 18/3206; C08G 18/341; C08G 2101/0025
USPC 428/319.1; 521/173; 428/304.4

(57) ABSTRACT

The present invention relates to a polyurethane/polyisocyanurate foam with improved dimensional stability. It relates further to the use thereof in the production of metal composite elements, to metal composite elements produced therewith, and to a method for producing metal composite elements.

The present invention relates to a polyurethane/polyisocyanurate foam with improved dimensional stability. It relates further to the use thereof in the production of metal composite elements, to metal composite elements produced therewith, and to a method for producing metal composite elements.

Metal sandwich elements based on rigid polyurethane (PU) foams, that is to say both rigid polyurethane (PUR) and rigid polyisocyanate (PIR) foams, have desirable properties with regard to heat insulation and fire behaviour. On account of this property, the metal sandwich elements, which are also called composite elements, are suitable for use in industrial building construction. Composite elements are used in particular in the construction of refrigerated warehouses. The composite elements are thereby permanently exposed to low temperatures in the range of from 0° C. to −30° C. However, it has been shown that composite elements shrink in terms of their thickness when they are permanently used under such conditions. This shrinkage then leads inter alia to undesirable stresses in the buildings constructed with the composite elements and to misalignment between individual composite elements and visual defects associated therewith.

Composite elements which have improved dimensional stability and at the same time continue to exhibit the advantageous properties of hitherto commercially available composite elements in terms of heat insulation and fire behaviour would therefore be desirable.

The above-mentioned properties of the composite elements are determined significantly by the polyurethane/polyisocyanurate foam used in the production of the composite elements.

Accordingly, it is an object of the present invention to provide polyurethane/polyisocyanurate foams which, upon processing, yield composite elements which have improved dimensional stability and at the same time continue to exhibit the advantageous properties of conventional composite elements in terms of heat insulation and fire behaviour.

The above-mentioned object is achieved by providing a polyurethane/polyisocyanurate foam, wherein the polyurethane/polyisocyanurate foam is obtainable from the reaction of

A) an isocyanate-reactive composition comprising

A1) from 0 to 15 wt. % of at least one polyester polyol having a hydroxyl number in the range of from 300 mg KOH/g to 1000 mg KOH/g, determined in accordance with DIN 53240,

A2) from 1 to 15 wt. % of at least one polyether polyol having a hydroxyl number in the range of from 300 mg KOH/g to 600 mg KOH/g, determined in accordance with DIN 53240, and

A3) from 50 to 70 wt. % of at least one polyester polyol having a hydroxyl number in the range of from 80 mg KOH/g to 290 mg KOH/g, determined in accordance with DIN 53240,

wherein the data in wt. % are based in each case on all the components of the isocyanate-reactive composition A);

with

B) a polyisocyanate component,

wherein the equivalent ratio of NCO groups to the sum of the hydrogen atoms reactive towards NCO groups is from ≧150:100 to ≦500:100,

characterised in that the polyether polyol A2) is a polyether polyol A2) started with an aromatic amine.

It is further provided according to the invention that the equivalent ratio of NCO groups to the sum of the hydrogen atoms reactive towards NCO groups is preferably from ≧150:100 to ≦400:100. This ratio can particularly preferably also be from ≧200:100 to ≦400:100.

The isocyanate-reactive composition preferably comprises from 1 to 10 wt. % of at least one polyester polyol A1), from 1 to 10 wt. % of at least one polyether polyol A2) and from 50 to 70 wt. % of at least one polyester polyol A3).

The polyester polyol A1) can be, for example, a polycondensation product of polyols and aromatic di- as well as optionally tri- and tetra-carboxylic acids or hydroxycarboxylic acids or lactones. Instead of the free carboxylic acids, the corresponding polycarboxylic anhydrides or corresponding polycarboxylic acid esters of lower alcohols can also be used for preparing the polyesters.

Examples of suitable polyols include ethylene glycol, (1,2)- and (1,3)-propylene glycol, (1,4)- and (2,3)-butylene glycol, (1,6)-hexanediol, (1,8)-octanediol, neopentyl glycol, 1,4-bis-hydroxymethyl-cyclohexane, 2-methyl-1,3-propanediol, glycerol, trimethylolethane, (1,2,6)-hexanetriol, (1,2,4)-butanetriol, quinol, methyl glucoside, triethylene glycol, tetraethylene glycol and higher polyethylene glycols, dipropylene glycol and higher polypropylene glycols, diethylene glycol, glycerol, pentaerythritol, trimethylolpropane, sorbitol, mannitol, dibutylene glycol and higher polybutylene glycols. Particularly suitable polyols are alkylene glycols and oxyalkylene glycols, for example ethylene glycol, diethylene glycol, dipropylene glycol, triethylene glycol, tripropylene glycol, tetraethylene glycol, tetrapropylene glycol, trimethylene glycol, tetramethylene glycol and 1,4-cyclohexanedimethanol (1,4-bis-hydroxymethylcyclohexane).

As aromatic dicarboxylic acids there can be used, for example, phthalic acid, isophthalic acid, terephthalic acid and/or tetrachlorophthalic acid. The corresponding anhydrides can also be used as the acid source.

Provided that the mean functionality of the polyol to be esterified is ≧2, monocarboxylic acids such as benzoic acid and hexanecarboxylic acid can additionally also be used concomitantly.

Hydroxycarboxylic acids which can be used concomitantly as reactants in the preparation of an aromatic polyester polyol having terminal hydroxyl groups are, for example, hydroxycaproic acid, hydroxybutyric acid, hydroxydecanoic acid, hydroxystearic acid and the like. Suitable lactones are caprolactone, butyrolactone and homologues. Caprolactone is preferred.

The polyester polyol A1) is preferably obtained from phthalic anhydride and diethylene glycol.

The polyester polyol A1) preferably has a hydroxyl number of from ≧300 mg KOH/g to ≦850 mg KOH/g and particularly preferably from ≧400 mg KOH/g to ≦850 mg KOH/g. Within the context of the present invention, hydroxyl numbers can generally be determined on the basis of DIN 53240. The average functionality of this polyester polyol A1) is advantageously from ≧1.8 to ≦2.2. The weight-average molecular weight of the polyester polyols Al) is preferably in the range of from 150 g/mol to 400 g/mol, particularly preferably in the range of from 150 g/mol to 300 g/mol, determined in accordance with DIN 55672-1.

The polyether polyol A2) preferably has a hydroxyl number of from ≧320 mg KOH/g to ≦550 mg KOH/g and particularly preferably from ≧350 mg KOH/g to ≦500 mg KOH/g. Within the context of the present invention, hydroxyl numbers can generally be determined on the basis of DIN 53240. The polyether polyol A2) is prepared by reacting at least one aromatic amine with at least one alkylene oxide. Preferred aromatic amines are selected from the group consisting of toluylenediamine, diaminodiphenylmethane and polymethylene-polyphenylene-polyamine.

There can preferably be used as the alkylene oxide ethylene oxide, propylene oxide or a mixture thereof. Ethylene oxide is particularly preferred.

The average functionality of this polyether polyol A2) is preferably 4. The weight-average molecular weight of the polyether polyols A2) is preferably in the range of from 300 g/mol to 1000 g/mol, particularly preferably in the range of from 350 g/mol to 800 g/mol, determined in accordance with DIN 55672-1.

The polyether polyols A2) are prepared by known processes, such as, for example, by anionic polymerisation with alkali hydroxides, such as, for example, sodium or potassium hydroxide, or alkali alcoholates, such as, for example, sodium methylate, sodium or potassium ethylate or potassium isopropylate, as catalysts and with the addition of at least one aromatic amine as starter molecule with one or more alkylene oxides having from 2 to 4 carbon atoms in the alkylene moiety.

The polyester polyol A3) can be a polycondensation product of at least one carboxylic anhydride, diethylene glycol, at least one further C₂-C₄ glycol, with the exception of diethylene glycol, and at least one aliphatic C₅-C₁₂ dicarboxylic acid. Alternatively, the polyester polyol A3) can be a polycondensation product of at least one carboxylic anhydride, diethylene glycol, at least one C₅-C₁₀ glycol and at least one C₄ dicarboxylic acid.

In a preferred embodiment, the carboxylic anhydride (A) is aromatic. The carboxylic anhydride (A) is preferably selected from the group consisting of phthalic anhydride, trimellitic anhydride and pyromellitic anhydride. The carboxylic anhydride is particularly preferably phthalic anhydride.

The C₂-C₄ glycol is preferably selected from the group consisting of ethylene glycol, 1,3-propanediol, 2-methyl-1,3-propanediol, 1,2-propanediol. The C₂-C₄ glycol is particularly preferably ethylene glycol. The aliphatic C₅-C₁₂ dicarboxylic acid is preferably selected from the group consisting of glutaric acid, adipic acid, pimelic acid, suberic acid, azelaic acid, sebacic acid, undecanedioic acid and dodecanedioic acid. Adipic acid or sebacic acid is particularly preferred as the C₅-C₁₂ dicarboxylic acid. The C₅-C₁₀ glycol is preferably selected from the group consisting of 1,5-pentanediol, 3-methyl-1,5-pentanediol, 1,6-hexanediol and 1,8-octanediol. The C₅-C₁₀ glycol is particularly preferably 3-methyl-1,5-pentanediol or 1,6-hexanediol. The C₄ dicarboxylic acid is preferably selected from the group consisting of succinic acid, fumaric acid and maleic acid. The C₄ dicarboxylic acid is particularly preferably succinic acid.

The polyester polyol A3) is particularly preferably a polycondensation product of phthalic anhydride, diethylene glycol, adipic acid and ethylene glycol.

The polyester polyol A3) preferably has a hydroxyl number of from ≧100 mg KOH/g to ≦290 mg KOH/g and particularly preferably from ≧180 mg KOH/g to ≦290 mg KOH/g. The weight-average molecular weight of the polyester polyols A3) is preferably in the range of from 350 g/mol to 750 g/mol, particularly preferably in the range of from 370 g/mol to 620 g/mol, determined in accordance with DIN 55672-1.

The mean functionality of the polyester polyols A3) is preferably in the range of from 1.9 to 3. Functionalities greater than 2 are obtained by the concomitant use of a proportion of structural units having functionalities greater than 2, for example triols or tetraols and/or tri- or tetra-carboxylic acids and/or trifunctional hydroxycarboxylic acids, in the esterification. Typical representatives are glycerol, 1,1,1-trimethylolpropane, pentaerythritol, trimellitic acid, trimesic acid, malic acid, tartaric acid, citric acid, dimethylolpropionic acid, etc. Preferably, a mean functionality in the range of from 2.0 to 2.3 can be established by using glycerol or 1,1,1-trimethylolpropane.

The polyisocyanate component B) comprises the polyisocyanates conventional in polyurethane chemistry. There come into consideration generally aliphatic, cycloaliphatic, arylaliphatic and aromatic polyvalent isocyanates. Aromatic di- and poly-isocyanates are preferably used. The polyisocyanate component particularly preferably comprises monomeric and/or polymeric diphenylmethane diisocyanate. For example, it can be 2,2′-, 2,4′- and 4,4′-diphenylmethane diisocyanate (MDI) and arbitrary mixtures of those isomers, mixtures of 2,2′-, 2,4′-, 4,4′-diphenylmethane diisocyanates (dinuclear MDI) or polyphenylene-polymethylene polyisocyanates (polymeric MDI). It is possible for further polyisocyanates to be present in the polyisocyanate component B). Preferred examples are 2,4- and 2,6-toluene diisocyanate (TDI) and arbitrary mixtures of those isomers.

In order to improve the fire resistance, flame retardants C) can additionally be added to the isocyanate-reactive compositions, preferably phosphorus-containing compounds, particularly preferably phosphates and phosphonates, as well as halogenated polyesters and polyols or chlorinated paraffins.

Flame retardants C) selected from the group consisting of tris(1-chloro-2-propyl) phosphate (TCPP) and triethyl phosphate (TEP) are particularly preferred. Flame retardants C) are preferably used in an amount of from 1 to 30 wt. %, particularly preferably from 5 to 30 wt. %, based on the total weight of the isocyanate-reactive composition.

Trimerisation catalysts D) are preferably added to the isocyanate-reactive composition. Trimerisation catalysts D) initiate and accelerate the trimerisation of isocyanate groups to isocyanurate groups.

Trimerisation catalysts D) selected from the group consisting of ammonium, alkali or alkaline earth metal salts of carboxylic acids are preferred. Trimerisation catalysts D) selected from the group consisting of potassium formate, potassium acetate, potassium (2-ethylhexanoate), ammonium formate, ammonium acetate, ammonium (2-ethylhexanoate), [1-(N,N,N-trimethylammonium)-propan-2-ol] formate and [1-(N,N,N-trimethylammonium)propan-2-ol] (2-ethylhexanoate) are particularly preferred.

Salts of carboxylic acids are preferably used as component D), particularly preferably salts of carboxylic acids having from 1 to 20 carbon atoms. These can be linear or branched, substituted or unsubstituted, saturated or unsaturated aliphatic or aromatic carboxylic acids.

The trimerisation catalysts D) can be used individually or in the form of a mixture.

Trimerisation catalyst D) is used in amounts of preferably from 0.1 to 10.0 wt. %, particularly preferably from 0.3 to 6.0 wt. %, in each case based on the total weight of the isocyanate-reactive composition.

Emulsifiers E) are preferably added to the isocyanate-reactive compositions. As suitable emulsifiers E), which also serve as foam stabilisers, there can be used, for example, all commercially available silicone oligomers modified by polyether side chains which are also used in the production of conventional polyurethane foams. If emulsifiers E) are used, the amounts thereof are preferably up to 8 wt. %, particularly preferably from 0.5 to 7 wt. %, in each case based on the total weight of the isocyanate-reactive composition. Preferred emulsifiers E) are polyether-polysiloxane copolymers.

The isocyanate-reactive compositions can also comprise compounds F), which can serve as physical foaming agents. There are preferably used as physical foaming agents F) low molecular weight hydrocarbons, such as, for example, n-propane, n-butane, n-pentane, cyclopentane, isopentane or mixtures thereof, dimethyl ethers, fluorinated hydrocarbons such as 1,1-difluoroethane or 1,1,1,2-tetrafluoroethane or CO₂.

The foam production can optionally take place solely by means of the physical foaming agents F). In most cases, however, the foam formation takes place by an additional reaction of the polyisocyanate component with component G) as chemical foaming agent. The amount of physical foaming agent F) required can thereby be reduced or foams with a lower density are obtained.

Component F) is particularly preferably low molecular weight hydrocarbons, most particularly preferably n-pentane. If the isocyanate-reactive compositions are foamed with physical foaming agents F), the amounts thereof are preferably from 0.1 to 30 parts by weight, particularly preferably from 0.1 to 25 parts by weight, in particular from 0.1 to 20 parts by weight, in each case based on the total weight of the isocyanate-reactive composition.

There can be used as chemical foaming agents G), for example, water or carboxylic acids such as formic acid.

If constituent G) is used, it is preferably hydroxy compounds, whereby water can be particularly preferred and liquid or gaseous.

There can further be used as additives H) all added ingredients which have hitherto also been used in isocyanate-reactive compositions. Examples of additives H) are cell regulators, thixotropic agents, plasticisers and colourants.

In a preferred embodiment, the present invention relates to a polyurethane/polyisocyanurate foam obtainable from the reaction of

A) an isocyanate-reactive composition comprising

A1) from 1 to 10 wt. % of at least one polyester polyol having a hydroxyl number in the range of from 300 mg KOH/g to 1000 mg KOH/g, determined in accordance with DIN 53240,

A2) from 1 to 10 wt. % of at least one polyether polyol having a hydroxyl number in the range of from 300 mg KOH/g to 600 mg KOH/g, determined in accordance with DIN 53240,

A3) from 50 to 70 wt. % of at least one polyester polyol having a hydroxyl number in the range of from 80 mg KOH/g to 290 mg KOH/g, determined in accordance with DIN 53240,

C) from 1 to 30 wt. % of at least one flame retardant,

D) from 0.1 to 6 wt. % of at least one trimerisation catalyst,

wherein the data in wt. % are based in each case on all the components of the isocyanate-reactive composition A);

with

B) a mixture of diphenylmethane 4,4′-diisocyanate with isomers and higher functional homologues, wherein the equivalent ratio of NCO groups to the sum of the hydrogen atoms reactive towards NCO groups is from ≧150:100 to ≦400:100,

characterised in that the polyether polyol A2) is a polyether polyol A2) started with an aromatic amine.

In a particularly preferred embodiment, the present invention relates to a polyurethane/polyisocyanurate foam obtainable from the reaction of

A) an isocyanate-reactive composition comprising

A1) from 1 to 10 wt. % of at least one polyester polyol having a hydroxyl number in the range of from 300 mg KOH/g to 1000 mg KOH/g, determined in accordance with DIN 53240,

A2) from 1 to 10 wt. % of at least one polyether polyol having a hydroxyl number in the range of from 300 mg KOH/g to 600 mg KOH/g, determined in accordance with DIN 53240,

A3) from 50 to 70 wt. % of at least one polyester polyol having a hydroxyl number in the range of from 80 mg KOH/g to 290 mg KOH/g, determined in accordance with DIN 53240,

C) from 1 to 30 wt. % of at least one flame retardant,

D) from 0.1 to 6 wt. % of at least one trimerisation catalyst,

E) from 0.5 to 6 wt. % of at least one emulsifier,

G) optionally at least one chemical foaming agent,

H) optionally at least one additive,

F) at least one physical foaming agent,

wherein the data in wt. % are based in each case on all the components of the isocyanate-reactive composition A);

with

B) a mixture of diphenylmethane 4,4′-diisocyanate with isomers and higher functional homologues, wherein the equivalent ratio of NCO groups to the sum of the hydrogen atoms reactive towards NCO groups is from ≧150:100 to ≦400:100,

characterised in that the polyether polyol A2) is a polyether polyol A2) started with an aromatic amine.

In an embodiment of the polyurethane/polyisocyanurate foams according to the invention, the foam has a density of from ≧30 kg/m³ to ≦50 kg/m³. The density is determined in accordance with DIN EN ISO 3386-1-98. The density is preferably in a range of from ≧33 kg/m³ to ≦45 kg/m³ and particularly preferably from ≧36 kg/m³ to ≦42 kg/m³.

For the production of the polyurethane/polyisocyanurate foams according to the invention, all the components, mixed by means of conventional high- or low-pressure mixing heads, are generally reacted in amounts such that the equivalent ratio of the NCO groups of the hydrogen atoms reactive towards NCO groups is from ≧150:100 to ≦500:100.

The present invention further provides the use of the polyurethane/polyisocyanurate foams according to the invention in the production of metal composite elements. For details of individual embodiments, reference is made, in order to avoid unnecessary repetition, to the explanations of the method according to the invention.

Metal composite elements are sandwich composite elements consisting of at least two covering layers and an intermediate core layer. In particular, metal/foam composite elements consist at least of two covering layers of metal and a core layer of a foam, for example a rigid polyurethane (PUR) foam or a rigid polyurethane/polyisocyanurate (PUR/PIR) foam. Such metal/foam composite elements are sufficiently well known from the prior art and are also referred to as metal composite elements. Further layers can be provided between the core layer and the covering layers. For example, the covering layers can be coated, for example with a lacquer.

Examples of the use of such metal composite elements are flat or lined wall elements as well as profiled roofing elements for industrial building and refrigerated warehouse construction as well as for HGV superstructures, building doors or transport containers.

The production of these metal composite elements can take place continuously or discontinuously. Devices for continuous production are known, for example, from DE 1 609 668 A or DE 1 247 612 A.

Metal composite elements produced using the polyurethane/polyisocyanurate foams according to the invention can have, for example, a value for the total smoke production after 600 seconds TSP₆₀₀ of from ≧45 m² to ≦60 m² according to EN 13823. The TSP₆₀₀ value can also be from ≧46 m² to ≦58 m² or from ≧47 m² to ≦55 m². Such metal composite elements can also have a value for the smoke development SMOGRA according to EN 13823 of from ≧1 m²/s² to ≦10 m²/s², preferably from ≧2 m²/s² to ≦8 m²/s², particularly preferably from ≧3 m²/s² to ≦6 m²/s².

The present invention further provides a metal composite element comprising a metal layer and a layer that comprises the polyurethane/polyisocyanurate foams according to the invention. Further details regarding metal composite elements have already been given in connection with the use of the foam according to the invention.

The present invention will be explained in greater detail by means of the following examples.

### EXAMPLES

### List of the Raw Materials Used in the Examples

Phthalic anhydride (PA): Commercial PA from Lanxess Deutschland GmbH

Adipic acid: Adipic acid from BASF

Diethylene glycol (DEG): DEG from Ineos

Ethylene glycol (EG): EG from Ineos

Tin(II) chloride dihydrate: from Aldrich

### Example 1

### Synthesis of Polyester A3)

1444 g (9.76 mol) of PA were placed, under a blanket of nitrogen, at 180° C., in an apparatus according to Example 1, and 1193 g (11.26 mol) of diethylene glycol were added slowly. After one hour, the temperature was lowered to 150° C. 356 g (2.44 mol) of adipic acid and 429 g (6.92 mol) of EG were added and the reaction was completed at 200° C. for 3 hours. 65 mg of tin(II) chloride dihydrate were added and the pressure was reduced to 300 mbar. In the course of a further 5 hours, the pressure was reduced continuously to a final value of 80 mbar and the reaction was completed to a total running time of 21 hours. Throughout the reaction, distillates were collected in a receiver cooled with dry ice. The hydroxyl number was determined as 199 mg KOH/g (calculated: 212 mg KOH/g), 160 g (1.51 mol) of diethylene glycol were added, and equilibration was carried out at normal pressure and 200° C. for 5 hours.

Analysis of the polyester:

Hydroxyl number: 239.7 mg KOH/g

Acid number: 2.1 mg KOH/g

### Examples for the Production of a Rigid PUR/PIR Foam

Components used:

Polyester polyols from Example 1

TCPP, tris(1-chloro-2-propyl) phosphate from Lanxess GmbH, Germany

TEP, triethyl phosphate from Levagard

Stabiliser, polyether-polysiloxane copolymer from Evonik

Carboxylic acid salt (PIR catalyst): Desmorapid® VP.PU 30HB13A from Bayer MaterialScience AG, Leverkusen, Germany

Carboxylic acid salt (PIR catalyst): Desmorapid® 1792 from Bayer MaterialScience AG, Leverkusen, Germany

Desmophen® VP.PU 1907: polyether polyol based on o-toluylenediamine, propylene oxide and ethylene oxide having an OH number of 460 mg KOH/g according to DIN 53240 from Bayer MaterialScience AG, Leverkusen, Germany

Additive 1132: polyester polyol of phthalic anhydride and diethylene glycol, OH number 795 mg KOH/g from Bayer MaterialScience AG, Leverkusen, Germany

Desmodur® VP.PU 44V70L, polymeric polyisocyanate based on 4,4′-diphenylmethane diisocyanate having an NCO content of about 31.5 wt. % from Bayer MaterialScience AG, Leverkusen, Germany.

On a laboratory scale, all the raw materials of the rigid foam formulation, with the exception of the polyisocyanate component, are weighed into a paper cup, adjusted to a temperature of 23° C., and mixed by means of a Pendraulik laboratory mixer (e.g. type LM-34 from Pendraulik), and volatilised foaming agent (pentane) is optionally added. The polyisocyanate component (likewise adjusted to a temperature of 23° C.) is then added to the polyol mixture, with stirring, the mixture is mixed intensively and the reaction mixture is poured into moulds which are lined with metal covering layers (from Corus). The foam hardness was determined after 2.5 minutes by means of an indentation method, and the maximum core temperature was determined after 8-10 minutes. The reaction was allowed to continue for at least a further 24 hours at 23° C., and then the following properties were determined:

BVD test in accordance with the Swiss standard test for determining the degree of combustibility of building materials of the Vereinigung kantonaler Feuerversicherungen [cantonal fire insurance association], 1988 edition, with supplements of 1990, 1994, 1995 and 2005 (obtainable from the Vereinigung kantonaler Feuerversicherungen, Bundesstr. 20, 3011 Bern, Switzerland).

TABLE 1
Composition of the foam systems

| | | Example | | |
|---|---|---|---|---|
| Component: | | 2 | 3 | 4 |
| Polyester polyol from Ex. 1 | [parts] | 64 | 64 | 64 |
| Polyether polyol based on TMP and | [parts] | 5 | 0 | 0 |
| ethylene oxide, functionality 2, OH number | | | | |
| 240 mg KOH/g | | | | |
| Desmophen ® VP.PU 1907 | [parts] | 0 | 5 | 5 |
| Additive 1132 | [parts] | 2.2 | 2.2 | 2.2 |
| Tris(1-chloro-2-propyl) phosphate, TCPP | [parts] | 20 | 20 | 20 |
| Triethyl phosphate, TEP | [parts] | 5 | 5 | 5 |
| Stabiliser | [parts] | 6 | 6 | 6 |
| Pentane | [parts] | 13.7 | 13.7 | 13.7 |
| Desmorapid ® VP.PU 30HB13A | [parts] | 3.4 | 3.4 | 3.4 |
| Desmorapid ® 1792 | [parts] | 0 | 0 | 0 |
| Desmodur ® 44V70L | | + | + | + |
| Index | | 360 | 360 | 360 |

The metal composite elements produced according to Examples 2 to 4 were stored for 14 hours at −20° C. The metal composite elements have a size of 1 m by 4 m. The thickness was determined by means of a sliding calliper at a distance of 300 mm from the original cut edge.

For a metal composite element that comprises a foam produced according to Example 2, an average deviation of 3.4 mm from the original thickness of 200 mm is found in a test series of 10 tests. For a metal composite element that comprises a foam produced according to Example 3, an average deviation of 2.1 mm from the original thickness of 200 mm is found in a test series of 10 tests. For a metal composite element that comprises a foam produced according to Example 4, an average deviation of 1.9 mm from the original thickness of 200 mm is found in a test series of 10 tests.

It is clear from the examples described above that metal composite elements that comprise the polyurethane/polyisocyanurate foam according to the invention have higher dimensional stability.

The rigid foams according to the invention of Examples 3 and 4 were further tested in respect of the fire behaviour in the Single Burning Item (SBI) test in accordance with EN 13823. To that end, commercial metal composite elements were produced with rigid foam according to the invention of Example 3 or 4 and subjected to the test. In the case of the FIGRA value (fire growth rate), classification of the metal composite elements in class B is possible. In the case of the THR₆₀₀ value (total heat release after 600 seconds), classification in class S2 is achieved. The metal composite elements with the rigid foams according to the invention accordingly exhibit a fire resistance that is comparable with the fire resistance of commercially available metal composite elements.

1.-12. (canceled)

13. A polyurethane/polyisocyanurate foam, obtained from the reaction of
A) an isocyanate-reactive composition comprising
A1) from 0 to 15 wt. % of at least one polyester polyol having a hydroxyl number in the range of from 300 mg KOH/g to 1000 mg KOH/g, determined in accordance with DIN 53240,
A2) from 1 to 15 wt. % of at least one polyether polyol having a hydroxyl number in the range of from 300 mg KOH/g to 600 mg KOH/g, determined in accordance with DIN 53240,
and
A3) from 50 to 70 wt. % of at least one polyester polyol having a hydroxyl number in the range of from 80 mg KOH/g to 290 mg KOH/g, determined in accordance with DIN 53240,
wherein the data in wt. % are based in each case on all the components of the isocyanate-reactive composition A);
with
B) a polyisocyanate component,
wherein the equivalent ratio of NCO groups to the sum of the hydrogen atoms reactive towards NCO groups is from ≧150:100 to ≦500:100,
wherein the polyether polyol A2) is a polyether polyol A2) started with an aromatic amine.

14. The polyurethane/polyisocyanurate foam according to claim 13, wherein the equivalent ratio of NCO groups to the sum of the hydrogen atoms reactive towards NCO groups is from ≧150:100 to ≦400:100.

15. The polyurethane/polyisocyanurate foam according to claim 13, wherein the isocyanate-reactive composition comprises from 1 to 10 wt. % of at least one polyester polyol A1), from 1 to 10 wt. % of at least one polyether polyol A2) and from 50 to 70 wt. % of at least one polyester polyol A3).

16. The polyurethane/polyisocyanurate foam according to claim 13, wherein polyisocyanate component B) comprises a mixture of diphenylmethane 4,4′-diisocyanate with isomers and higher functional homologues.

17. The polyurethane/polyisocyanurate foam according to claim 13, wherein the isocyanate-reactive composition comprises trimerisation catalysts D) selected from the group consisting of ammonium, alkali, and alkaline earth metal salts of carboxylic acids.

18. The polyurethane/polyisocyanurate foam according to claim 13, wherein the aromatic amine is selected from the group consisting of toluylenediamine, diaminodiphenylmethane and polymethylene-polyphenylene-polyamine.

19. A method for producing a composite element comprising utilizing the polyurethane/polyisocyanurate foam according to claim 13.

20. A composite element comprising at least one covering layer and at least one layer that comprises a polyurethane/polyisocyanurate foam according to claim 13.

21. The composite element according to claim 20, wherein the covering layer is a metal layer.

22. A method for producing a composite element comprising applying, in at least one step a reaction mixture comprising components A) and B) according to claim 13, to a covering layer.

23. The method according to claim 22, wherein the covering layer is a metal layer.

24. The method according to claim 22, wherein the method is configured as a twin conveyor belt method.
